(19) United States
(12) Patent Application Publication
(10) Pub. No.: US 2019/0211288 A1
(43) Pub. Date: Jul. 11, 2019

(54) METHOD AND APPARATUS FOR TREATING A SUBSTRATE WITH SOLID PARTICLES

(71) Applicant: Xeros Limited, Rotherham, South Yorkshire (CN)

(72) Inventors: Jessica Anne POTTS, Rotherham, South Yorkshire (GB); Frazer John KENNEDY, Rotherham, South Yorkshire (GB)

(21) Appl. No.: 16/093,433

(22) PCT Filed: Apr. 13, 2017
(86) PCT No.: PCT/GB2017/051048

§ 371 Date: Oct. 12, 2018

(30) Foreign Application Priority Data
Apr. 15, 2016 (GB) 1606638.3

(51) Int. Cl. C11D 11/00; D06F 35/00; D06F 33/02

(52) U.S. Cl. CPC C11D 11/0064; D06F 23/02; D06F 33/02; D06F 35/005

(57) ABSTRACT

A method for treating a substrate comprising the steps of: (i) rotating a composition comprising a liquid medium, the substrate and solid particles having a particle size of from 1 to 100 mm; (ii) separating at least some of the solid particles from the substrate; and (iii) rinsing the substrate; wherein: steps ii. and iii. are each performed at least twice and the first time steps ii and iii are conducted the sequence of steps is either i, ii, iii, ii or i, iii, ii, iii; and/or during the separation step ii. the composition is rotated for a first time period at a centripetal G force of <1 G and for a second time period at a centripetal force of >1 G and at least one of the first and second time periods is no longer than 60 seconds.

This invention relates to a method for treating a substrate with solid particles and to an apparatus for carrying out said method. The method offers further improvements in the separation of the solid particles from the substrate, especially when the substrate is flexible including for example textiles, hides, skins and pelts. The method is especially suited to laundry cleaning.

### BACKGROUND

The use of solid particles in cleaning methods is known in the art. For example, WO-2007/128962-A discloses a method for cleaning a soiled substrate using a multiplicity of polymeric particles.

WO-2011/098815-A discloses an apparatus for cleaning a soiled substrate. It also discloses the preferred centripetal G forces which when used in the wash cycle help to improve the wash performance. This publication does not address ways to improve the particle separation at the end of the wash cycle.

WO-2015/067965-A discloses a method for cleaning a soiled substrate. It goes on to disclose two distinct ranges of centripetal G forces which can be used in the cleaning steps to improve the cleaning performance.

Whilst the above disclosures provide excellent cleaning performance and good separation of the solid particles from the substrate further improvements in particle separation are required without unduly sacrificing cleaning performance and without the necessity for unduly long total cycle times.

Without being limited by theory, it was surprisingly observed that when the rinse and separation cycles were ordered in a particular sequence and/or when the separation cycle utilised short timescale pulses of higher and lower centripetal G forces, the resulting separation of solid particles from the substrate was markedly improved. This is an especially desirable goal for domestic laundry where the end user would prefer to experience final cleaned substrates with as few solid particles as possible. Desirably, the present inventors found that this discovery lead to advantageous improvements in separation of the solid particles without necessarily extending the total wash/cleaning cycle time. Accordingly, the present invention provides for the first time an exceptional balance of wash performance, short total cycle time and separation efficiency.

### FIGURES

FIG. 1 is a cross-sectional representation of the apparatus used in and according to the present in the present invention.

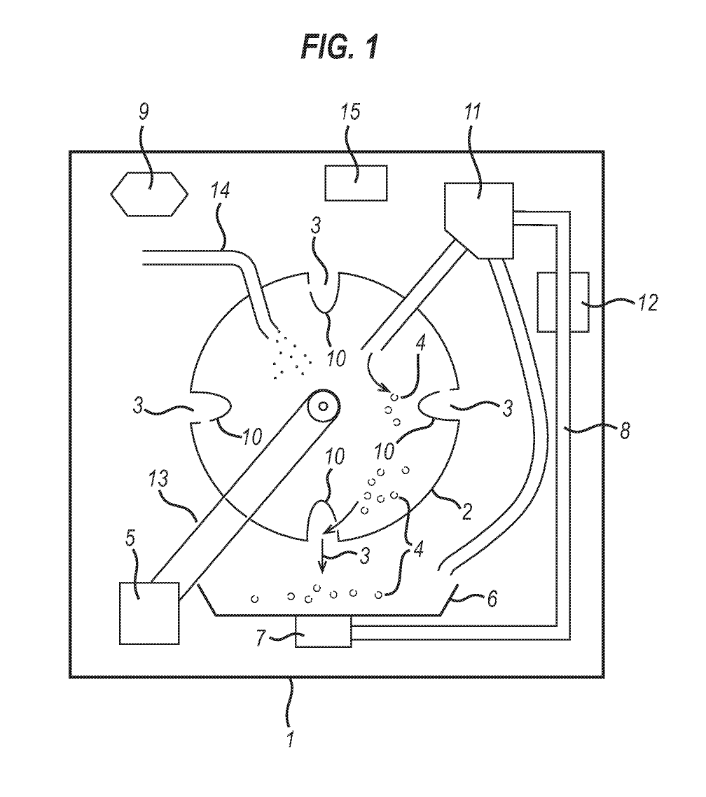

### DESCRIPTION

According to a first aspect of the present invention there is provided a method for treating a substrate comprising the steps of:
i. rotating a composition comprising a liquid medium, the substrate and solid particles having a particle size of from 1 to 100 mm;
ii. separating at least some of the solid particles from the substrate; and
iii. rinsing the substrate;
   wherein:
   steps ii. and iii. are each performed at least twice and the first time steps ii and iii are conducted the sequence of steps is either i, ii, iii, ii or i, iii, ii, iii;
   and/or
   during the separation step ii. the composition is rotated for a first time period at a centripetal G force of <1G and for a second time period at a centripetal force of ≥1G and at least one of the first and second time periods is no longer than 60 seconds.

Treating

Preferably, treating is or comprises: cleaning, tanning, abrading, finishing, bleaching, sterilizing and colouring the substrate including combinations thereof.

Preferably, cleaning is or comprises laundering.

Preferably, the desired treatment of the substrate method is effected substantially in step i. For instance, where the treatment is or comprises cleaning, the cleaning of the substrate occurs primarily in step i.

Liquid Medium

The liquid medium preferably is or comprises water. The liquid medium may comprise organic liquids but these are preferably present at less than 30 wt %, more preferably less than 20 wt %, even more preferably less than 10 wt % and especially less than 2 wt % based on the weight of the liquid medium. Suitable organic liquids include alcohols, ethers, amides and esters. Preferably, the liquid medium is water.

Substrate

Preferred substrates are flexible.

Preferred flexible substrates include hides, skins, pelts and especially textiles.

Preferably, the substrate is or comprises a textile.

Tanning is preferably carried out using substrates which are hides, skins or pelts.

Cleaning or laundering is preferably carried out using substrates which are textiles.

Preferred textile substrates may be synthetic, semi-synthetic, natural or combinations thereof.

Preferred synthetic textiles include textiles containing nylon, polyester and acrylic.

Preferred natural textiles include wool, cotton and silk.

Method

Preferably, during step ii., and preferably also during step iii., solid particles are not introduced (added) to the substrate or composition. Preferably, solid particles are not introduced (added) to the substrate or composition after the end of step i. Preferably, solid particles are not introduced (added) to the substrate or composition in any step other than step i.

Preferably, during step ii. solid particles are separated from the substrate whilst no solid particles are transferred back to the substrate or composition.

Preferably, the separation step is such that the ratio of solid particles to substrate is decreasing. When the method is performed in a drum it is preferred that the drum contains fewer solid particles as the separation steps (i.e. steps ii.) proceed.

It will be appreciated that washing and cleaning steps mentioned in the prior art implicitly or inherently contemplate introducing or adding solid particles to a composition comprising the substrate and/or making no efforts to separate the particles during the washing/cleaning steps, on the basis that the particles are advantageous for the washing/cleaning step.

The present inventors surprisingly found that the order of the separation and rinse steps according to the present invention markedly increases the separation efficiency, for example relative to a method wherein the order is i. ii. iii. or i. iii. ii. The sequence of steps in the method of the present invention is superior even when the total amount of time for both separation and rinsing are kept constant.

In the method of the present invention, one or more additional optional step(s) other than i, ii and iii. can be interposed or added anywhere in the sequence according to the present invention. One or more additional step(s) i, ii and/or iii (and preferably one or more additional step(s) ii. and/or one or more additional step(s) iii.; and preferably not an additional step i.) may also be interposed or added anywhere in the sequence according to the present invention with the proviso that the same step does not directly follow itself (for example ii, ii) because this is in effect simply a longer or more involved step ii.

Preferably, in the method of the invention, the steps ii. and iii. are each performed at least twice and the method comprises steps in the order i, ii, iii, ii, iii or i, iii, ii, iii, ii. Preferably, the method comprises the steps in the order i, ii, iii, ii, iii.

The method of the invention can comprise the steps in the order i, (ii, iii)n, or i, (iii, ii)n where n is an integer representing the number of times the sequence in brackets is repeated and having a value of from 2 to 10, preferably from 2 to 8, more preferably from 2 to 6 and especially from 2 to 4.

Preferably, the separating step ii. is performed no more than 20 times, more preferably no more than 10 times and especially no more than 8 times.

Preferably, the separating step ii. is performed from 2 to 20 times, more preferably from 2 to 10 times, especially from 2 to 8 times.

Preferably, the rinsing step iii. is performed no more than 20 times, more preferably no more than 10 times and especially no more than 8 times.

Preferably, the rinsing step iii. is performed in increasing order of preference from 2 to 20 times; from 2 to 10 times; from 2 to 8 times; from 2 to 6 times; from 2 to 4 times or 2 times.

Preferably, the method additionally comprises one or more spin drying steps iv.

A spin drying step is preferably performed using a centripetal force of 10G or more, more preferably from 10G to 2000G, and especially from 50G to 1000G.

Preferably, the spin drying step is performed in a drum having a plurality of holes which permit egress of the liquid medium when the centripetal G forces are as preferred above. These holes may be exit points for the solid particles (as mentioned below) or they may have a size such that the solid particles are not permitted to exit these holes but liquid medium can exit the holes. Typically, these holes have a size of from 1 mm to 8 mm, more typically from 3 to 6 mm.

Spin drying steps (iv.) tend not to effectively separate the solid particles from the substrate because the centrifugal forces tend to be so high as to pin or trap the solid particles in the substrate as they are pressed against the internal walls of the drum.

Prior to each spin step (iv.) it is preferable to rotate the substrate at a centripetal force as defined herein for the second time period. This centripetal force prior to the spin step is preferably from 2 to 8G, more preferably from 2 to 6G.

Preferably, the method comprises or consists of steps in the order i, ii, iii, iv, ii, iii, iv and optionally ii.

Preferably, the method comprises or consists of steps in the order i, ii, iii, ii, iv, ii, iii, ii, iv and optionally ii.

Preferably, the spin drying step iv. is performed no more than 5, more preferably no more than 3 times.

Preferably, the total time for all the separating steps is no more than 60 minutes, more preferably no more than 40 minutes.

Preferably, the total time for all the separating steps is from 5 to 40 minutes.

Preferably, at least one separating step is performed for at least 1 second, more preferably for at least 10 seconds. Preferably, every separation step is performed for at least 1 second, more preferably at least 10 seconds.

Preferably, at least one separating step is performed for no more than 30 minutes, more preferably for no more than 20 minutes. Preferably, every separation step is performed for no more than 30 minutes, more preferably for no more than 20 minutes.

Preferably, each separating step is performed for a time period of from 10 seconds to 20 minutes.

Preferably, the total time for all the rinsing steps is no more than 40 minutes, more preferably no more than 20 minutes.

Preferably, the total time for all the rinsing steps is from 1 minute to 40 minutes, more preferably from 1 to 20 minutes.

Preferably, at least one rinsing step is performed for a time period of from 15 seconds to 10 minutes. Preferably, every rinsing step is performed for a time period of from 15 seconds to 10 minutes.

Preferably, at least one of the first and second time periods is no longer than 30 seconds, more preferably no longer than 15 seconds, even more preferably no longer than 10 seconds and especially no longer than 5 seconds. Preferably, both the first and second time periods have the preferred durations mentioned.

Preferably, each of the first and second time periods performed in the method are no longer than 60 seconds, more preferably no longer than 30 seconds.

The first and/or second time periods are preferably at least 0.1 second, more preferably at least 1 second in duration.

Preferably, the centripetal forces in the first and second time periods differ within a short time period. Whilst not wishing to be limited by any theory the present inventors have found that the use of centripetal forces which change over short time period(s) assists in freeing and separating the solid particles from the substrate. The present inventors have discovered that short first and/or second time periods are more effective for separation. Short first and/or second time periods permit these periods to be repeated many times during the separation steps which consequently means the overall proportion of the separation time whilst the composition is accelerating or decelerating is increased. The present inventors consider that much of the benefits of improved separation using first and second time periods can be attributed to an increase in the overall proportion of time for which the composition is accelerating or decelerating.

Preferably, the time interval between the end of a first time period and the start of the following second time period is no more than 30 minutes, more preferably no more than 15 seconds, especially no more than 10 seconds, more especially no more than 5 seconds and yet more especially no more than 1 second, and preferably said second time period starts immediately after said first time period ends.

Where a further first time period follows a second time period in a separation step ii., preferably, the time interval between the end of said second time period and the start of the following further first time period is no more than 30 minutes, more preferably no more than 15 seconds, especially no more than 10 seconds, more especially no more than 5 seconds and yet more especially no more than 1 second, and preferably said further first time period starts immediately after said second first time period ends.

Preferably, at least some, more preferably all of the first and second time periods (in particular in any given separation step ii.) are separated by no more than 30 minutes, more preferably by no more than 15 seconds, especially no more than 10 seconds, more especially no more than 5 seconds and yet more especially no more than 1 second. It is most preferred that the first and second time periods directly follow each other.

Preferably, the substrate is present in a rotatable drum during at least the separating step ii, but more preferably in all steps i, ii, iii and when present iv. The drum is preferably predominantly cylindrical in shape. Preferably, the drum has a radius of from 10 to 100 cm, more preferably from 10 to 50 cm and more especially from 20 to 40 cm. Preferably, the drum has a capacity such that it is capable of holding from 1 to 20 Kg, more preferably from 5 to 15 Kg of dry substrate.

The centripetal force as mentioned in all parts of the present invention preferably relates to the centripetal force as experienced on the inner walls of the rotatable drum furthest from the axis of rotation.

Mathematically, the centripetal force can be calculated by equation (1):

G=1.118×10⁻⁵rR² (1)

wherein r is the radius of the drum in centimetres and R is the speed of rotation of the drum in revolutions per minute (rpm). Hence using this equation a centripetal G force of 2.00G is experienced on the inner wall of a drum rotating at a speed of 80 rpm if it has a radius of 28 cm.

Preferably, for at least some of the duration of any separating step ii. the centripetal force is less than 10G, more preferably no more than 9G, even more preferably no more the 8G and especially no more than 7G. Preferably, a separating step ii. is performed using a centripetal force which never exceeds 9.9G, 9G, 8G or 7G at any point in time.

Preferably, the centripetal force in the first time period differs from the centripetal force in the second time period by at least 0.2G, more preferably by at least 0.5G and especially by at least 0.7G. The present inventors consider that the increase (or pulse) in centripetal forces causes a motion in the substrate which very much assists in the release and separation of the solid particles from the substrate. The present inventors have found that if the centripetal G force is too high in the second time period, the separation of the solid particles from the substrate is not improved as much. Whilst not wishing to be limited by theory it is considered that when the centripetal force is too high the substrate is constrained or squashed and the solid particles are effectively held in place and prevented from separating.

Preferably, the centripetal force in the first time period differs from the centripetal force in the second time period by no more than 6G, more preferably by no more than 5G, even more preferably by no more than 3G and especially by no more than 2.5G.

As described hereinabove, the centripetal G force in the second time period is higher than that in the first time period according to the method of the present invention.

Preferably, during the separation step ii. the substrate is rotated for a first time period at a centripetal force of from 0.1G to 0.8G and more preferably from 0.2 to 0.8G.

Preferably, during the separation step ii. the substrate is rotated for a second time period at a centripetal force of less than 10G, preferably from 1.2G to less than 10G, preferably from 1.2G to 9G, preferably from 1.2G to 7G, more preferably from 1.2G to 5G and especially from 1.2G to 3G.

In the method of the present invention, there may be (and preferably is) a plurality of “first time periods” and/or a plurality of “second time periods”. Where there are a plurality of first time periods, the centripetal force in each first time period may be the same or different. Equally, where there are a plurality of second time periods, the centripetal force in each second time period may be the same or different.

Preferably, the first and second time periods are performed alternately.

In each time period it is possible to rotate the composition at two or more speeds and thereby achieve two or more centripetal forces. As an example it is possible to use two or more rotation speeds, each of which provides a centripetal force of less than 1G in a first time period.

Preferably, the first and second time periods are each repeated at least 5 times, more preferably at least 10 times and especially at least 20 times in total. Preferably, the first and second time periods are each repeated no more than 500 times, more preferably no more than 300 times in total.

Preferably, the first and second time periods are each repeated at least 3 times in at least one of the separating steps, more preferably the first and second time periods are each repeated at least 5 times in at least one of the separating steps. Preferably, the first and second time periods are each repeated at least 3 times in every separating step.

Preferably, centripetal force is increasing or decreasing for at least 5%, more preferably for at least 10%, especially at least 15% and more especially at least 20% of the total time during at least one of the separation steps.

Preferably, centripetal force is increasing or decreasing for at least 5%, more preferably for at least 10%, especially at least 15% and more especially at least 20% of the total time during each of the separation steps.

It is possible that the centripetal force is increasing or decreasing for 100% of the time during at least one of the separation steps, more typically though the centripetal force is increasing or decreasing for less than 90%, even more typically for less than 80% of the time of at least one of the separation steps. The percentages can apply also to the total time of all the separating steps present in the method.

Preferably, the total rinsing time takes from 1 to 20% of the total duration of the method.

Preferably, the total separation time takes from 10 to 50%, preferably from 20 to 40%, preferably from 25 to 35%, of the total duration of the method.

Preferably, the total duration of the method is from 30 minutes to 3 hours, more preferably from 30 minutes to 1.5 hours.

It will be appreciated that the step of rotating in the method of the present invention is suitably effected by rotation of a treatment chamber in which the substrate is contained. As discussed herein the treatment chamber is preferably in the form of a drum.

The method of the present invention may comprise periods in which the substrate is not rotated. The present inventors refer to these periods as “dwell periods”. Preferably, the substrate is not rotated for one or more periods of from 0.1 to 60 seconds, more preferably from 0.1 to 30 seconds, especially from 0.1 to 10 seconds before recommencing rotation. Said dwell periods can be present in any one or more of steps i, ii or iii. Preferably, step i. comprises the abovementioned dwell periods. Preferably, dwell periods do not interpose the first and second time periods.

Preferably, in any of steps i, ii and iii. the substrate can be rotated. The direction of rotation is preferably changed intermittently. Preferably, the rotation is sometimes clockwise and sometimes anti-clockwise. Preferably, during the at least one of the separating steps the rotation is sometimes clockwise and sometimes anti-clockwise, more preferably during each of the separating steps the rotation is sometimes clockwise and sometimes anti-clockwise. The present inventors have found that changing the direction of rotation helps to prevent or reduce the extent of substrate twisting which can make separation of the solid particles all the more difficult.

Preferably, the duration of rotation in a given direction (i.e. clockwise or anti-clockwise) is of from 10 seconds to 10 minutes, more preferably from 10 seconds to 5 minutes, and preferably the direction of rotation is then changed to to the other direction

Preferably, the rotation is clockwise or anti-clockwise for periods of from 10 seconds to 10 minutes before changing to the other direction.

The method may be utilised for industrial (>1 tonne of dry substrate), commercial (from 12 Kg to 1 tonne of dry substrate) or domestic scales (less than 12 Kg of dry substrate) of operation. The method is especially suitable to domestic cleaning, especially domestic laundry.

Preferably, steps ii. and iii. are each performed at least twice and the method comprises steps in the order i, ii, iii, ii or i, iii, ii, iii; and during the separation step ii. the composition is rotated for a first time period at a centripetal G force of <1G and for a second time period at a centripetal force of ≥1G and at least one of the first and second time periods is no longer than 60 seconds. This combines the best of all possible separating efficiency benefits.

Solid Particles

Preferably, the solid particles have a particle size of from 1 to 15 mm, more preferably from 1 to 10 mm and especially from 1 to 9 mm. Particles having a size of from 3 to 8 mm are particularly suitable.

The size is preferably an average size, more preferably an average taken from at least 10, at least 100 or more preferably at least 1000 particles.

Preferably, the particle size of the solid particles is measured along the longest linear dimension.

The longest linear dimension is preferably measured by calipers.

The particles can be made of any material including metals, alloys, ceramics, glass and polymers including mixtures thereof. Polymers are especially preferred. Thermoplastic polymers including polyamides, polyesters, polyalkylenes and polyurethanes are preferred.

The particles can be foamed or unfoamed.

The particles can be a composite for example comprising both a polymeric material and an inorganic material. Suitable inorganic materials include fillers.

Preferably, the solid particles have a density of from 1 to 3 g/cm³, more preferably from 1 to 2.5 g/cm³ and especially from 1.2 to 2.5 g/cm³. Such densities offer improved separation which is of assistance in the invention.

The solid particles can be of any shape including spheres, ellipsoids, cubes, cylinders and shapes which are intermediate between any of these. Preferably, the solid particles are spheres or ellipsoids as such shapes tend to separate better. Preferably, the solid particles have substantially no projections, edges or vertices. Preferably, the surface of the particles is smooth.

When the treating is cleaning or laundering it is preferred that the particle is or comprises a polyamide, especially a nylon, more especially Nylon 6 and/or Nylon 6,6.

When the treating is tanning or colouring it is preferred that the particle is or comprises a polyalkylene, especially polyethylene or polypropylene.

Rinsing

The rinsing step iii. is preferably performed using water. The rinse water may be simply poured onto the composition but it is more preferably sprayed onto the composition.

The water is preferably clean water, for instance mains water. Thus, the water used in the rinsing step is typically water which has not previously been used in, or recycled from, the method.

Optional Additives

The composition may additionally comprise optional additives.

When treating is or comprises cleaning or laundering it is preferred that the composition additionally comprises a detergent. Preferably, the detergent comprises at least one surfactant.

When treating is or comprises tanning it is preferred that the composition additionally comprises a tanning agent. The tanning agent can be a chromium compound (e.g. chromium (Ill) sulphate) or a chromium free tanning agent such as a tannin.

When treating is or comprises colouring it is preferred that the composition additionally comprises a colourant. The colourant may be a pigment but is preferably a dye.

When treating is or comprises bleaching it is preferred that the composition additionally comprises a bleaching agent. Suitable bleaching agents include hypochlorite, percarbonate, perborate and the like including optional bleach catalysts.

When treating is or comprises abrading it is preferred that the composition additionally comprises one or more of the following components: a bleaching agent; an enzyme and a detergent.

When treating is or comprises sterilizing it is preferred that the composition additionally comprises one or more antimicrobial agents. The antimicrobial agents can be a biocide, an anti-viral, a fungicide, an algaecide or a combination thereof.

When the treating is or comprises finishing it is preferred that the substrate is or comprises a natural fibre, especially a substrate comprising wool and/or cotton.

Apparatus

Preferably, the apparatus used to perform the method of the present invention comprises a housing (1). Preferably, the housing takes the form of a frame, especially a metal or alloy frame.

As mentioned above the method is preferably performed in a treatment chamber, which is typically a drum (2). Accordingly, the preferred apparatus for performing the present method comprises a drum. The drum is preferably rotatable. Preferably, the drum is mounted in the housing. The drum may be rotated about a vertical axis, a horizontal axis or any angles therebetween. Preferably, the drum is rotatable at angles of from 0 to 15 degrees from the horizontal.

The drum preferably has one or more lifters (10), more preferably from 1 to 8 and especially from 1 to 6 lifters. Lifters are preferably protrusions in the drum which extend substantially down the length of the drum, preferably parallel to the axis of rotation.

Preferably, the drum has exit points (3) such that solid particles and liquid medium can exit the drum. The exit points can be or comprise holes in the drum surface, more specifically the exit points can be between optional lifters (if present) and/or more preferably there can be exit points in optional lifters which are attached to or integral with the drum.

The exit points can take the form of holes. The holes can be of any shape including: circles, ovals, squares, rectangles, slots and the like.

The exit points have a size larger than the size of the solid particles. Preferably, the drum has holes which are no larger than 20 mm, more preferably no larger than 19 mm, even more preferably no larger than 14 mm, especially no larger than 10 mm. Such relatively large holes are preferably present in the lifters rather than on the surface of the drum between the lifters.

Preferably, the drum surface between the lifters has holes (which are not exit points for the solid particles) which are smaller than the size of the solid particles. Accordingly, in this case the liquid medium can exit the drum via the holes between the lifters e.g. during a spin step iv. but the solid particles can only exit via the exit points in the lifters having the larger holes.

Preferably, between lifters the drum has such smaller holes, which are no larger than 6 mm.

Preferably, the particle size of the solid particles is from 6 mm to 9 mm, preferably the drum has holes between lifters having a size of no larger than 6 mm and preferably the lifters have holes of around 10 mm.

It is preferred that the solid particles have a size which is at least 0.2 mm, more preferably at least 0.5 mm smaller than the size of the exit points, particularly the size of the exit points in the lifters.

The size of the exit points is preferably the smallest linear dimension, for circular holes the size corresponds to the diameter. For slots, the smallest linear dimension corresponds to the width rather than the length of the slot.

The apparatus preferably comprises a motor (5). The motor is preferably an electric motor. The motor may directly drive the drum but more typically the drum is connected to the motor by means of a drive belt (13).

The apparatus preferably comprises a sump (6). The sump is preferably suitable for storing solid particles. The sump is preferably located beneath the drum. The sump is preferably connected to the drum and is configured so that the liquid medium and solid particles may exit the drum via exit points and enter the sump. Preferably, the sump has angled sides which assist in directing the solid particles towards an optional pump when present.

The apparatus preferably comprises a pump (7). Preferably, the pump is connected to the sump. Preferably, the pump is an electric pump. Preferably, the pump is a fluid, more preferably a liquid pump. Preferably, the pump is capable of pumping a mixture of the liquid medium and solid particles.

Preferably, the apparatus comprises a circulation pathway (8) by which solid particles can be pumped from the sump to the drum. Preferably, the circulation pathway comprises pipes, tubes, ducts, channels or the like.

Preferably, the apparatus comprises an electronic controller (9). Preferably, the electronic controller is configured to control the operation of the apparatus, the electronic controller comprising a processor and a memory comprising logical instructions that when executed by the processor cause the apparatus to execute the method according to the present invention.

Preferably, the electronic controller is configured to control rotation speed in the method, particularly the rotation speed of the drum.

Preferably, the electronic controller is configured to control the direction of rotation in the method, particularly the direction of rotation of the drum.

Preferably, the electronic controller can control the operation of the pump.

Preferably, the electronic controller can control the introduction of water for rinsing.

Preferably, the electronic controller is configured to control the heater and/or to control the temperature of the composition during the treatment.

Preferably, the apparatus comprises a heater (12).

Preferably, the apparatus comprises a supply of water (14) for rinsing.

Preferably, the apparatus has a user interface (15) so that the setting of the electronic controller can be adjusted and preferably so that the progress of the treatment can be displayed. The user interface preferable is in the form of a display panel, especially one fitted with buttons, dials, switches or even more preferably a touch screen.

According to a second aspect of the present invention there is provided an apparatus for treating a substrate comprising:

a housing (1);
a rotatable drum (2) mounted in the housing, said drum having exit points (3) such that solid particles (4) can exit the drum;
a motor (5);
a sump (6) suitable for storing solid particles;
a pump (7);
a circulation pathway (8) by which solid particles can be transported from the sump to the drum;
an electronic controller (9) configured to control the operation of the apparatus, the electronic controller comprising a processor and a memory comprising logical instructions, suitably wherein the logical instructions when executed by the processor cause the apparatus to execute the method according to the present invention.

The preferences for the apparatus according to the second aspect of the present invention e.g. the housing, rotatable drum, exit points, solid particles, motor, sump, pump, circulation pathway and electronic controller etc. are as hereinbefore mentioned.

Preferably, the apparatus comprises a separator (11). The separator functions to separate solid particles and liquid medium. Preferably, the separator is located along the circulation pathway. Preferably, the separator returns a stream containing some of the liquid medium but no particles back to the sump. Preferably, the separator transfers a mixture of solid particles along with some of the remaining liquid medium along the remainder of the circulation pathway into the drum. The separator serves to reduce the overall amounts of liquid medium needed by the apparatus. The separator can also serve to increase the performance of the treatment. Thus, the cleaning or washing performance can be improved by utilising an apparatus comprising a separator.

The present invention will now be exemplified and further elaborated by means of the following non limiting examples.

### Examples

Separation Experiments

Separation performance experiments were performed using ellipsoidal Nylon solid particles having a size of about 6.5 mm and a density of about 1.65 g/cm³.

Separation tests were performed using a washing apparatus as described herein having had an electronic controller programmed so as to be capable of operating the method according to the first aspect of the present invention. The drum had 4 lifters each having exit points with a size of 10 mm and having holes between the lifters of around 5 mm.

The treatment was a cleaning cycle which was carried out using 5.5 kg of mixed clothing as ballast. The clothing used was as tabulated in Table 1. The types of clothing were chosen to be especially difficult in regard of particle separation and thus represented a significant challenge.

TABLE 1
Clothing used as ballast

| Number of items | Item type |
|---|---|
| 4 | Men's Long sleeved shirts |
| 1 | Men's jeans |
| 1 | Women's jeans |
| 1 | Child's jeans |
| 1 | Women's zip up hoody (with pockets) |
| 1 | Men's t-shirt |
| 2 | Men's polo shirts |
| 1 | Men's rugby shorts (with pockets) |
| 1 | Men's jogging bottoms (with pockets) |
| 2 | Women's vest tops |
| 1 | Bath towel |
| 3 | Hand towels |
| 1 | Women's dress |
| 1 | Childs t-shirt |
| 1 | Women's lace top |

Each treatment (cleaning cycle) was run for a total duration of 66 minutes at a temperature of 20° C. using 45 gms of Tide High Efficiency laundry detergent. 12 kg of solid particles were used in all cases. The liquid medium was water. The rinse liquid was water.

The clothing was loaded into the drum of the apparatus, the drum was rotated. The drum had a radius of 28 cm. For such a drum size a rotation speed of 56.5 rpm corresponds to a centripetal force of 1G at the inner walls of the drum.

Three variations of cleaning methods were tested in Experiments 1 to 3. In each case the washing period of the cycle (i.e. step i.) remained unaltered. The remaining steps including steps ii. (separating) and step iii. (rinsing) were as described below.

Experiment 1

In stage 0, the substrate was wetted with water (liquid medium) whilst rotating at 47 rpm for a period of 6 minutes.

In stage 1, which is step i according to the method of the invention, the pump was activated in pulses of 2 lots of 20 seconds so as to transfer the Nylon particles from the sump into the drum. The transfer of the Nylon particles took approximately 1 minute in total (with some intervals between the pump pulses). The detergent and water were introduced via a spray nozzle to the wash load (substrate), this process took approximately 2 minutes. The nylon particles (solid particles) were recirculated through the drum and sump etc via the pump in the apparatus for a period of 20 minutes in this step. The drum was rotated clockwise at 47 rpm. During this rotation the pump was operated in pulses for 5 seconds on followed by 15 seconds off. After approximately 1 minute of rotation, the drum stopped rotating (dwelled) for a period of 4 seconds. After each “dwell” the drum was rotated again at 47 rpm but in the opposite direction and the pump began pulsing again as mentioned above. For this drum size 47 rpm corresponds to a centripetal G force of 0.69G. After step i. the pump is not operated again at any point.

In stage 2, which is a step ii according to the method of the invention, the pump was not operated and so no solid particles entered the drum or were introduced to the composition or substrate. In this step ii, the drum was rotated as follows: 47 rpm for 10 seconds, 70 rpm for 4 seconds, 36 rpm for 10 seconds, 70 rpm for 4 seconds and then 47 rpm for 10 seconds. The whole sequence was repeated but in the opposite direction. The rotation speeds 47 and 36 rpm correspond to a centripetal force of below 1G and thus correspond to the first time period, the rotation speed of 70 rpm corresponds to a centripetal force of 1.53G and thus corresponds to the second time period. This represented the first separating step which took approximately 1 minute.

In stage 3, which is a step iii according to the method of the invention, 10 litres of clean water was sprayed onto the contents of the drum. The spraying was performed whilst the drum was rotated at 47 rpm. This represented the first rinsing step. Again the drum was rotated in each direction for approximately 20 to 30 seconds before “dwelling” for 4 seconds and then rotating in the opposite direction. Stage 3 took approximately 4 minutes.

In stage 4, which is a step ii according to the method of the invention, the procedure as outlined is stage 2 was repeated. In addition, the drum was briefly rotated at 100 rpm and dropped back to 47 rpm before being again rotated at 100 rpm and then 47 rpm. Stage 4 took approximately 2 minutes.

In stage 5, which is a step iv according to the method of the invention, the drum was rotated from 3 minutes at a speed of 500 rpm. This spin speed corresponds to a centripetal G force of 78.3G. The spin was effective in removing most of the water and much of the remaining detergent from the clothing. Stage 5 took approximately 4 minutes.

In stage 6, which is a step ii according to the method of the invention, the drum was initially rotated as follows: 10 seconds at 47 rpm, 4 seconds at 70 rpm, 10 seconds at 36 rpm, 4 seconds at 80 rpm, 10 seconds at 47 rpm. The different rotation speeds were performed for a period of approximately 1 minute. The whole sequence was repeated but with the rotation in the opposite direction. This part of stage 6 took approximately 2 minutes. In the second part of stage 6, the drum was rotated in one direction at rotation speeds of 25 rpm, 40 rpm and 90 rpm changing speed every 2 to 4 seconds. The rotation was continued in one direction for 1 minute before the same sequence was repeated but with the rotation in the opposite direction. This part of stage 6 took approximately 2 minutes.

In stage 7, which is a step iii according to the method of the invention, 8 litres of clean water were sprayed onto the contents of the drum. This corresponds to a second rinsing step. Stage 7 took approximately 4 minutes.

In stage 8, which is a step ii according to the method of the invention, stage 4 was repeated. Stage 8 took approximately 2 minutes.

In stage 9, which is a step iv according to the method of the invention, the drum was rotated at a speed of 800 rpm for a period of 4 minutes. This assists in removing the water from the clothing and thereby partially drying the clothing.

In stage 10, which is a step ii according to the method of the invention, the drum was rotated at speeds of 90 rpm, 25 rpm and 40 rpm whilst changing the speed every 2 or 3 seconds. After a period of a minute the sequence was repeated but with the rotation in the opposite direction. The rotation direction was changed at the end of each 1 minute interval. This stage was continued for 12 minutes.

This completed the cleaning method for Experiment 1.

Experiment 2

Experiment 2 was repeated in exactly the same way as Experiment 1 except that the separation stages 2, 4, 6, 8 and 10 were all aggregated and combined. The combined separating stages/steps were performed after all of the steps iii and iv. and in substantially the same place where stage 10 resides in Experiment 1. Thus Experiment 2 does not perform the steps in the order i, ii, iii, ii or i, iii, ii, iii. To put it another way, in Experiment 2 the rinse and separation steps are not alternated. Example 2 remains an example of the method of the present invention because it uses the required first and second time periods during the separation steps ii.

Experiment 3

Experiment 3 was repeated in exactly the same way as Experiment 1 except that in all of the separation steps ii. the drum rotation speeds were only 47 rpm, i.e. below a centripetal force of 1G. Accordingly, in Experiment 3 there were no second time periods. Example 3 remains an example of the method of the present invention because it did perform the steps in the order i, ii, iii, ii and each of steps ii. and iii. are performed twice.

Methods

After each experiment the clothing was removed from the drum. Any solid particles still remaining in the drum, entangled in the clothing or in pockets, seams, crevices or the like were removed and counted. Each experiment was repeated 5 times and the average number of remaining solid particles was calculated.

Results

The results for Experiments 1 to 3 were as indicated in Table 2.

| Experiment | Particles remaining (average of 5x) |
|---|---|
| Experiment 1 | 3.2 |
| Experiment 2 | 6.8 |
| Experiment 3 | 6.8 |

Lower numbers of remaining solid particles indicated a more successful and effective separation process.

Table 2 shows that both the order of the separation/rinse cycles and the first and second time periods separately provide good separation of the solid particles. Importantly, when both of these aspects are combined the resulting separation efficiency is further improved.

Desirably, the present invention provides a method and apparatus which is capable of providing treated (especially cleaned) substrates wherein the remaining amounts of solid particles are so small as to be almost negligible.

Experiments 1 was repeated except that stain sheets comprising stains such as sebum, carbon black, blood, cocoa, and wine were added to the wash. After the cleaning experiment the stain sheets were dried and the stains were evaluated using a spectrophotometer. The results showed that the present invention achieved excellent particle separation whilst maintaining good cleaning performance.

General

In the present invention integers, features, steps or requirements mentioned in the singular also encompass the plural. Accordingly, the word “a” where appropriate will often have the same meaning as “one or more”. Thus, as a few examples: “a substrate” means one or more substrates, similarly “a first time period” means one or more first time periods and a pump means one or more pumps.

1. A method for treating a substrate comprising the steps of:
i. rotating a composition comprising a liquid medium, the substrate and solid particles having a particle size of from 1 to 100 mm;
ii. separating at least some of the solid particles from the substrate; and
iii. rinsing the substrate;
wherein:
steps ii. and iii. are each performed at least twice and the first time steps ii and iii are conducted the sequence of steps is either i, ii, iii, ii or i, iii, ii, iii; and/or
during the separation step ii. the composition is rotated for a first time period at a centripetal G force of <1G and for a second time period at a centripetal force of ≥1 G and at least one of the first and second time periods is no longer than 60 seconds.

2. A method according to claim 1 wherein during step ii. solid particles are not introduced to the substrate or composition, and preferably solid particles are not introduced to the substrate or composition after the end of step i.

3. A method according to claim 1 or 2 which comprises steps in the order i, ii, iii, ii.

4. A method according to claim 1 or 2 which comprises steps in the order i, ii, iii, ii, iii or which comprises steps in the order i, iii, ii, iii, ii, and preferably which comprises steps in the order i, ii, iii, ii, iii.

5. A method according to any one of the preceding claims wherein the separating step ii. is performed from 2 to 10 times.

6. A method according to any one of the preceding claims wherein the rinsing step iii. is performed from 2 to 10 times.

7. A method according to any of the preceding claims wherein the method comprises the steps in the order i, (ii, iii)n, or i, (iii, ii)n where n is an integer representing the number of times the sequence in brackets is repeated and having a value of from 2 to 10.

8. A method according to any one of the preceding claims which additionally comprises one or more spin drying steps iv.

9. A method according to claim 8 which comprises or consists of steps in the order: i, ii, iii, iv, ii, iii, iv and optionally ii.

10. A method according to claim 8 which comprises or consists of steps in the order: i, ii, iii, ii, iv, ii, iii, ii, iv and optionally ii.

11. A method according to any one of claims 8 to 10 wherein the spin drying step iv. is performed no more than 3 times.

12. A method according to any one of the preceding claims wherein the total time for all the separating steps is from 5 to 40 minutes.

13. A method according to any one of the preceding claims wherein at least one separating step is performed for a time period of from 10 seconds to 20 minutes.

14. A method according to any one of the preceding claims wherein the total time for all the rinsing steps is from 1 minute to 20 minutes.

15. A method according to any one of the preceding claims wherein at least one rinsing step is performed for a time period of from 15 seconds to 10 minutes.

16. A method according to any one of the preceding claims wherein at least one of the first and second time periods is no longer than 30 seconds, or no longer than 15 seconds.

17. A method according to any one of the preceding claims wherein at least one of the first and second time periods is no longer than 10 seconds or no longer than 5 seconds.

18. A method according to any one of the preceding claims wherein the time interval between the end of a first time period and the start of the following second time period is no more than 15 seconds.

19. A method according to any one of the preceding claims wherein, where a further first time period follows a second time period in a separation step ii., the time interval between the end of said second time period and the start of the following further first time period is no more than 15 seconds.

20. A method according to any one of the previous claims wherein the centripetal force in the first time period differs from the centripetal force in the second time period by at least 0.2G or by at least 0.5G.

21. A method according to claim 19 wherein the centripetal force in the first time period differs from the centripetal force in the second time period by at least 0.7G.

22. A method according to any one of the preceding claims wherein during the separation step ii. the substrate is rotated for a first time period at a centripetal force of from 0.1G to 0.8G.

23. A method according to claim 22 wherein during the separation step ii. the substrate is rotated for a first time period at a centripetal force of from 0.2 to 0.8G.

24. A method according to any one of the preceding claims wherein during the separation step ii. the substrate is rotated for a second time period at a centripetal force of from 1.2G to less than 10G, preferably from 1.2G to 9G, preferably from 1.2G to 7G, preferably from 1.2G to 5G.

25. A method according to any one of the preceding claims wherein the first and second time periods are performed alternately.

26. A method according to any one of the preceding claims wherein the first and second time periods are each repeated at least 5 times in total.

27. A method according to any one of the preceding claims wherein the first and second time periods are each repeated at least 10 times in total.

28. A method according to any one of the preceding claims wherein the first and second time periods are each repeated at least 3 times in at least one of the separating steps.

29. A method according to any one of the preceding claims wherein the first and second time periods are each repeated at least 5 times in at least one of the separating steps.

30. A method according to any one of the preceding claims wherein the first and second time periods are each repeated at least 3 times in every separating step.

31. A method according to any one of the preceding claims wherein centripetal force is increasing or decreasing for at least 5% of the total time during at least one of the separation steps.

32. A method according to any one of the preceding claims wherein the centripetal force is increasing or decreasing for at least 20% of the total time during at least one of the separation steps.

33. A method according to any one of the preceding claims wherein the centripetal force is increasing or decreasing for at least 5% of the time during every one of the separation steps.

34. A method according to any one of the preceding claims wherein the total rinsing time takes from 1 to 20% of the total duration of the method.

35. A method according to any one of the preceding claims wherein the total separation time takes from 10 to 50% of the total duration of the method.

36. A method according to any one of the preceding claims wherein the total time taken is from 30 minutes to 3 hours.

37. A method according to any one of the preceding claims wherein the total time taken is from 30 minutes to 1.5 hours.

38. A method according to any one of the preceding claims wherein the solid particles have a particle size of from 1 to 15 mm.

39. A method according to any one of the preceding claims wherein the particle size of the solid particles is measured along the longest linear dimension by calipers.

40. A method according to any one of the preceding claims wherein the substrate is not rotated for one or more periods of from 0.1 to 60 seconds before recommencing rotation.

41. A method according to claim 40 wherein the substrate is not rotated for a period of 0.1 to 10 seconds.

42. A method according to any one of the preceding claims wherein during the at least one of the separating steps the direction of rotation is sometimes clockwise and sometimes anti-clockwise.

43. A method according to claim 42 wherein the rotation is clockwise or anti-clockwise for periods of from 10 seconds to 10 minutes before changing to the other direction.

44. A method according to any one of the preceding claims wherein treating is or comprises: cleaning, tanning, abrading, finishing, bleaching, sterilizing and colouring the substrate including combinations thereof.

45. A method according to any one of the preceding claims wherein the substrate is or comprises a textile material.

46. An apparatus for treating a substrate comprising:
a. a housing;
b. a rotatable drum mounted in the housing, said drum having exit points such that solid particles can exit the drum;
c. a motor;
d. a sump suitable for storing solid particles;
e. a pump;
f. a circulation pathway by which solid particles can be transported from the sump to the drum;
g. an electronic controller configured to control the operation of the apparatus, the electronic controller comprising a processor and a memory comprising logical instructions that when executed by the processor cause the apparatus to execute the method according to any one of claims 1 to 45.
